(19) United States
(12) Patent Application Publication
(10) Pub. No.: US 2010/0219703 A1
(43) Pub. Date: Sep. 2, 2010

(54) Magnet motor

(76) Inventor: Christopher D. Waller, Alamo, CA (US)

Correspondence Address: Zachary T. Wobensmith , III, 7746 101st Court, Vero Beach, FL, 32967-2871, US

(21) Appl. No.: 12/380,395

(22) Filed: Feb. 27, 2009

(51) Int. Cl. H02K 7/075; H02K 33/00

(52) U.S. Cl. 310/24

(57) ABSTRACT

A magnet motor is disclosed which includes at least one cylinder with a piston therein, the piston has a permanent magnet affixed to the top with electromagnetic coils around the cylinder, which are selectively actuated to pull the permanent magnet and piston up and down in the cylinder. The movement of the permanent magnet past the coils generates electricity which is fed back into the electro-magnets. Rotation of the crankshaft continues as long as electricity is fed to the electro-magnets.

### BACKGROUND OF THE INVENTION

1. Field of the Invention

This invention relates to a magnet motor, and more particularly to a magnet motor of the type which is powered by a plurality of electro-magnets.

2. Description of the Prior Art

Magnet motors are well known in the art, and have been used for many years. Magnet motors are illustrated in the prior art in U.S. Pat. Nos. 4,317,058 and 4,399,368, but these motors do not operate with a high degree of efficiency nor do they produce a consistent output.

### SUMMARY OF THE INVENTION

A magnet motor is disclosed which includes a piston and a cylinder of non-magnetic material, and a plurality of electromagnets and permanent magnets to operate the motor

The principal object of the invention is to provide a magnet motor that can be utilized with a variety of end products.

A further object of the invention is to provide a magnet motor that operates with a high degree of efficiency.

A further object of the invention is to provide a magnet motor that is simple and inexpensive to manufacture, but durable and long lasting in operation.

Other objects and advantageous features of the invention will be apparent from the description and claims.

### DESCRIPTION OF THE DRAWINGS

The nature and characteristic features of the invention will be more readily understood from the following description taken in connection with the accompanying drawings in which:

FIG. 1 is a sectional view of one embodiment of the motor of the invention;

FIG. 2 is an external side elevational view taken at the right side of FIG. 1; of another embodiment of the invention;

FIG. 3 is a view similar to FIG. 1 but showing the piston of the invention in a down position, the electro-magnet circuitry, and;

FIG. 4 is a view similar to FIG. 3 showing additional circuitry of the invention.

It should, of course, be understood that the description and drawings herein are merely illustrative and that various modifications and changes can be made in the structures disclosed without departing from the spirit of the invention.

Like numerals refer to like parts throughout the several views.

### DESCRIPTION OF THE PREFERRED EMBODIMENTS

When referring to the preferred embodiments, certain terminology will be utilized for the sake of clarity. Use of such terminology is intended to encompass not only the described embodiments, but also technical equivalents, which operate and function in substantially the same way to bring about the same result.

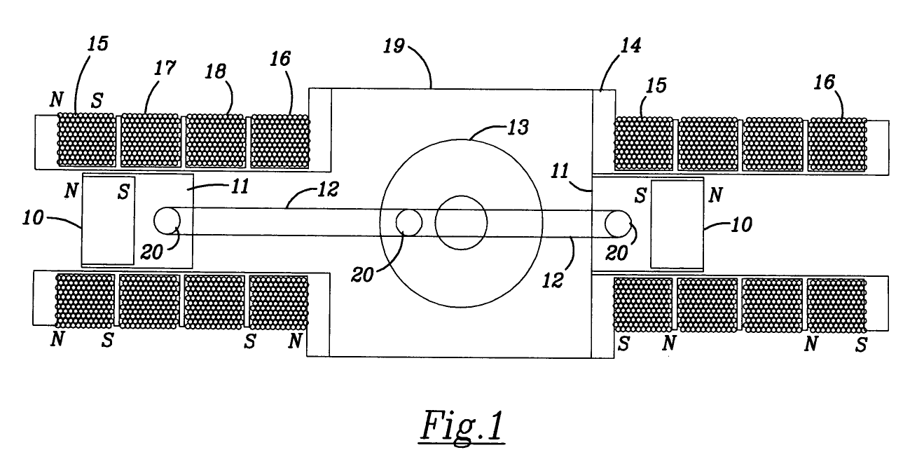

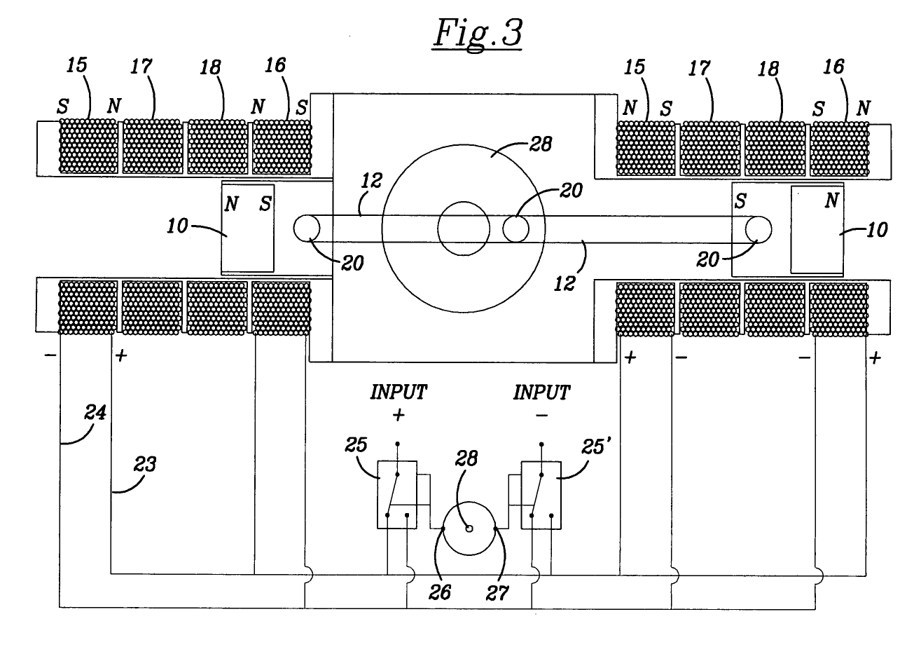

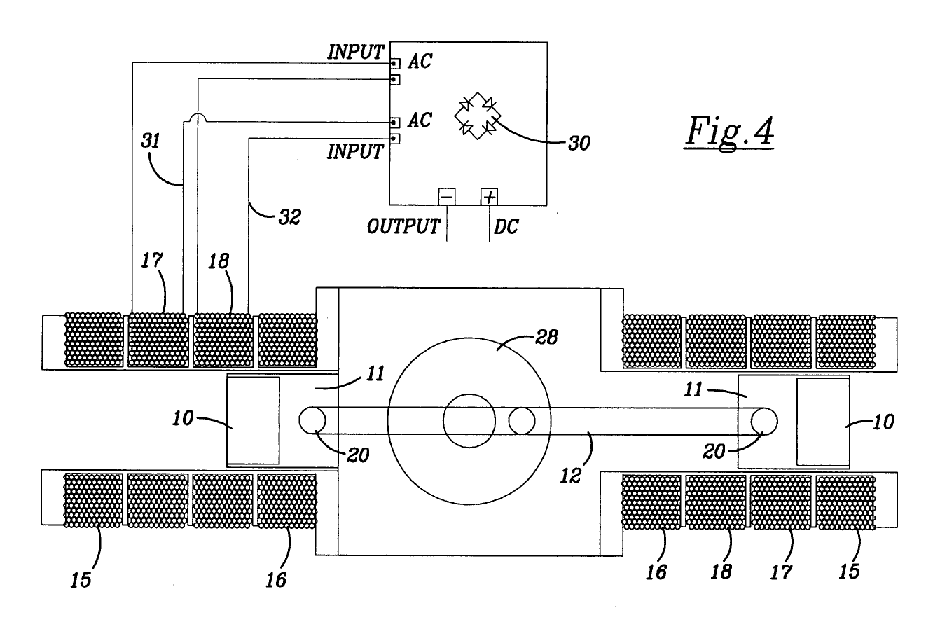

Referring now to more particularly to FIGS. 1, 3 and 4 of the drawings, one embodiment of the magnet motor 9 of the invention is therein illustrated. The magnet motor 9 includes a cylinder 14, which is of non-magnetic material of well known type suitable for the application. The piston 11 is connected to a crankshaft 13 by a connecting rod 12, and wrist pin 20 and has a magnet 10 affixed to piston 11 at the top in well known manner.

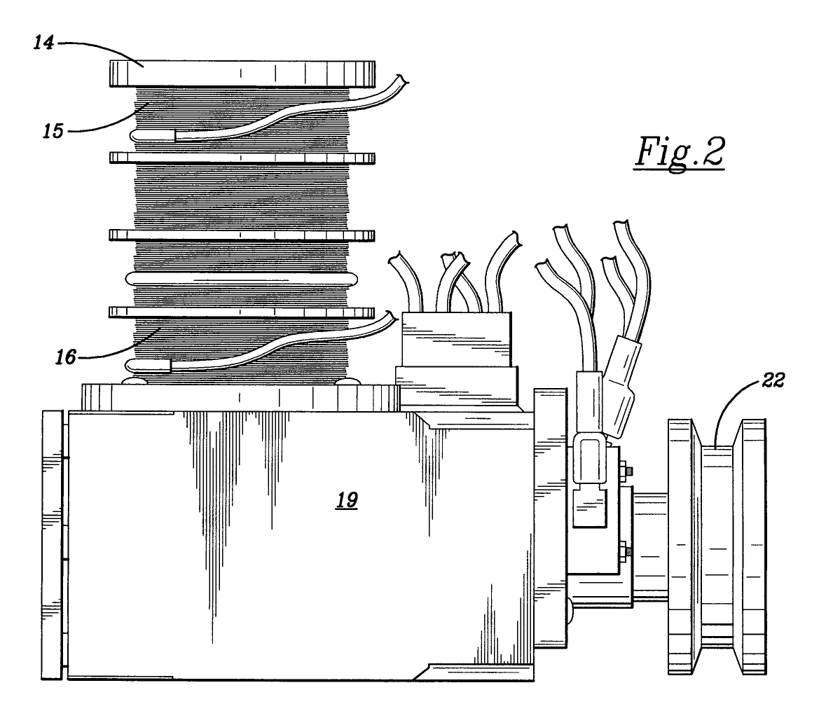

The crankshaft 13 is in bearings (not shown) in a crankcase 19, and has an output pulley 22. The output pulley 22 as shown in FIG. 2 can be connected as desired.

Referring additionally to FIG. 2, the cylinder 14 is provided with a plurality of top and bottom electromagnets 15 and 16, which are illustrated as coils and extend around the cylinder 14, are connected by wires 23 and 24 to switches 25, and 25′ which are actuated by alternatively acting cams 26 and 27. The cams 26 and 27 are carried on a crankshaft 28 in communication with crankshaft 13, in well known manner to change the polarity of the electro-magnets 15, 16 17 and 18 to be described.

To cause the motor 9 to be operated. there is an input of electrical energy at the switches 25 and 25′ which is nominally 12 volts D.C., wherein the electromagnetic coils 15, 16 17, and 18, are actuated and their polarity changed so that the permanent magnet 10 and piston 11 are pulled up and forced down in the cylinder 14. The crankshaft 13 is rotated and its output pulley 22 is thereby rotated. The rotation of the crankshaft 13 causes the cams 26 and 27 to be rotated, switches 25 and 25′ are actuated, and the piston 11 and magnet 10 to be moved up and down in the cylinder 14, or cylinders 14. The movement of permanent magnet 10 past the coils 17 and 18 causes electricity to be generated and carried back to rectifier 30 by wires 31 and 32. The rotation of the crankshaft 13 will continue as long as the coils 15 and 16 continue to be provided with electrical energy.

It will thus be seen that structure has been provided with which the objects of the invention are attained.

1. (canceled)

2. A motor as defined in claim 1 5 in which said cylinders are opposed.

3. A motor as defined in claim 1 5 in which said movement of said permanent magnet past said activation coils generates electricity.

4. A motor as defined in claim 1 5 in which Said cylinder is of non-magnetic material

5. A magnet motor which comprises
at least one cylinder
a piston in said cylinder connected to a crankshaft said piston has a permanent magnet affixed thereto,
at least one generation electro-magnet around said cylinder,
at least one activation coil around said cylinder,
whereby the movement of said permanent magnet past said activation coil provides electricity,
cam means in said cylinder actuated by the rotation of said crankshaft, and
switch means in communication with cams means to selectively provide electricity to said excitation electro-magnets, whereby said crankshaft and said output pulley are rotated.
